(19) United States
(12) Patent Application Publication
(10) Pub. No.: US 2010/0318973 A1
(43) Pub. Date: Dec. 16, 2010

(54) METHOD AND APPARATUS FOR PROVIDING DYNAMIC ACTIVATION OF VIRTUAL PLATFORM SUB-MODULES

(76) Inventors: Tino Rautiainen, Ylinen (FI); Jani L. Hyvonen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/482,177

(22) Filed: Jun. 10, 2009

(51) Int. Cl. G06F 9/44

(52) U.S. Cl. 717/135

(57) ABSTRACT

An apparatus for providing dynamic virtual platform sub-module activation may include at least one processor and at least one memory storing computer program code configured to, with the at least one processor, cause the apparatus or another apparatus to perform at least receiving an indication, from software being executed via a virtual platform comprising a software representation of hardware, of a request to access a sub-module of the virtual platform, and activating the sub-module requested from an initial deactivated state in response to the indication received. A corresponding method and computer program product are also provided.

### TECHNOLOGICAL FIELD

Embodiments of the present invention relate generally to virtual platforms and, more particularly, relate to an apparatus and method for providing dynamic activation of virtual platform sub-modules.

### BACKGROUND

In order to provide easier or faster information transfer and convenience, telecommunication industry service providers are continually developing improvements to existing communication networks. Concurrent with the improvements made to networks, the electronic communication devices that are used in connection with these networks are also continually improving. The improvement of networks and the communication devices that utilize these networks has resulted in wide availability and wide usage of a vast array of services and applications.

The services and applications that are developed, and continue to be developed are typically supported by a combination of hardware platforms and corresponding software. For example, a new mobile telephone may include improved hardware supporting battery saving technology, new display technology, increased processing speed and other improvements. Meanwhile, the enhanced capabilities provided by the improved hardware may enable the new mobile phone to run corresponding new software. Thus, in many situations, a release of a new product involves the release of both new software and new hardware. Moreover, new software applications often provide excellent material for creating a “buzz” when marketing new products, while new hardware capabilities may be less interesting to the casual user. Thus, it is very important that software development be enabled to start as early as possible from a business perspective, in order to ensure that overall time in getting the product to market can be minimized.

Accordingly, from a business perspective, it would be advantageous to be able to proceed with software development before the hardware itself is actually completed. For example, if an application specific integrated circuit (ASIC) or other specific hardware is being developed, but samples have not yet been produced, it may be advantageous to enable software development to proceed in parallel to the production of samples of the specific hardware. To enable this process, virtual platforms have been developed. A virtual platform is essentially simulated or virtual hardware. For example, a virtual platform may be a simulated ASIC and/or other hardware running on a personal computer (PC) environment. Thus, a virtual platform may be a virtual prototype of the hardware that will ultimately be produced, but without the physical hardware. Essentially, the virtual platform models the behavior of the hardware and other hardware characteristics such as timings, transactors, data storage, etc., via software instructions that are executed by a host device (e.g., a PC). In this regard, for example, the virtual platform may include a number of modules or sub-modules that each include instructions for modeling a particular characteristic, activity, function, timing, power analysis or capability of the hardware. Since the virtual platform is provided by a software package, the virtual platform may in some cases be available in a very short time and well before the physical hardware would be available. By using a virtual platform, software development and testing may proceed without dependence on the availability of physical samples of the hardware that will be used to ultimately execute the software.

Despite the obvious advantages of enabling developers to perform software development without dependence on the availability of physical hardware samples, virtual platforms do suffer from some disadvantages. In this regard, developers often report slowness as a negative aspect of simulated virtual hardware platforms. Slowness can be particularly problematic when developing software that is intended to run on a complex hardware platform or when the abstraction level of the virtual platform is low (e.g., when timings are included). Thus, the simulated hardware embodied by the virtual platform, which may be running on a PC, may heavily load the PC's processing capabilities and running the software being developed may actually be slower as compared to running the software in a real hardware environment.

In an effort to mitigate the slowness that impacts virtual platform operating speeds, developers can sometimes deactivate certain sub-modules that may not be used for the software being developed. Since the deactivated sub-modules are not active, processing resources of the PC will not be devoted to these sub-modules and processing speed may be increased. However, since the deactivation is essentially manually accomplished, the deactivated sub-modules will be completely unavailable until they are manually reactivated.

### BRIEF SUMMARY OF EXEMPLARY EMBODIMENTS

A method and apparatus are therefore provided that may enable the provision of dynamic activation of virtual platform sub-modules. Accordingly, an initial deactivated state may be applied to the sub-modules. Thereafter, when the software attempts to access a particular sub-module, the sub-module requested may be dynamically activated by a simulator engine to enable the requested sub-module to interface with the software. By providing an initial deactivation state for the sub-modules with selective activation, resource consumption of a processor (e.g., central processing unit (CPU)) for a device hosting the virtual platform may be reduced or minimized. However, due to the dynamic activation capability that is provided for needed or desired sub-modules, a user or developer can be provided with fast operation of desired portions of the virtual platform.

In one exemplary embodiment, a method of providing dynamic virtual platform sub-module activation is provided. The method may include an access, from software being executed via a virtual platform comprising a software representation of hardware, to a sub-module of the virtual platform, and activating the sub-module requested from an initial deactivated state in response to the access.

In another exemplary embodiment, a computer program product for providing dynamic virtual platform sub-module activation is provided. The computer program product may include at least one computer-readable storage medium having computer-executable program code instructions stored therein. The computer-executable program code instructions may include program code instructions for an access, from software being executed via a virtual platform comprising a software representation of hardware, to a sub-module of the virtual platform, and activating the sub-module accessed from an initial deactivated state in response to the access.

In another exemplary embodiment, an apparatus for providing dynamic virtual platform sub-module activation is provided. The apparatus may include at least one processor and at least one memory storing computer program code configured to, with the at least one processor, cause the apparatus or another apparatus to perform at least an access, from software being executed via a virtual platform comprising a software representation of hardware, to a sub-module of the virtual platform, and activating the sub-module requested from an initial deactivated state in response to the access.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic block diagram of an apparatus for providing dynamic virtual platform sub-module activation according to an exemplary embodiment of the present invention;

FIG. 2 illustrates a control flow diagram of one example of a process of dynamic activation of virtual platform sub-modules according to an exemplary embodiment of the present invention;

FIG. 3 illustrates a control flow diagram of another example of a process of dynamic activation of virtual platform sub-modules with a potential for subsequent de-activation according to an exemplary embodiment of the present invention; and

FIG. 4 illustrates a flowchart of a method of providing dynamic activation of virtual platform sub-modules in accordance with an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being communicated, sent, transmitted, received and/or stored in accordance with embodiments of the present invention. Additionally, the terms “module” and “sub-module” are used interchangeably herein to refer to a portion or part, but these terms do not necessarily suggest that the portions or parts associated therewith are isolated from each other or “modular” in that they do not, or could not, share certain code segments or instructions. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to dynamic activation of sub-modules of a virtual platform. In this regard, for example, rather than requiring a user or developer to manually deactivate particular sub-modules that are not expected to be used in connection with software being run, developed or tested in a virtual platform environment, embodiments of the present invention selectively activate requested sub-modules. Thus, for example, unlike conventional situations where the developer must know which sub-modules will not be used during the entirety of the operation of particular software in order to deactivate those sub-modules in advance, embodiments of the present invention provide a deactivated default state and selectively activate desired sub-modules to minimize resource consumption of the host platform.

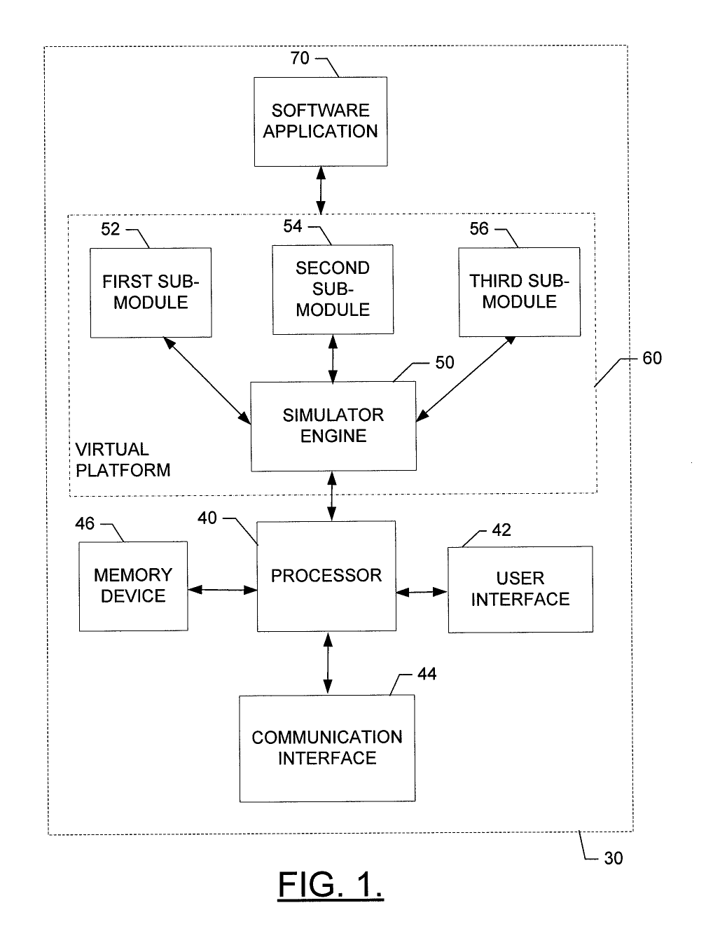

FIG. 1 illustrates a schematic block diagram of an apparatus for providing dynamic virtual platform sub-module activation according to an exemplary embodiment of the present invention. The apparatus 30 may be employed in connection with a PC or other computing device that includes computing resources in the form of hardware such as processing circuitry and memory for storing instructions executable by the processing circuitry. As such, the PC may act as a host platform for a hardware simulating platform or virtual platform as described herein. However, it should be noted that the components, devices or elements described below may not be mandatory and thus some may be omitted in certain embodiments. Additionally, some embodiments may include further components, devices or elements beyond those shown and described herein.

Thus, according to an exemplary embodiment, the apparatus 30 may include a processor 40, a user interface 42, a communication interface 44 and a memory device 46. The memory device 46 may include, for example, one or more volatile and/or non-volatile memory devices. The memory device 46 may be configured to store information, data, applications, instructions or the like for enabling the apparatus to carry out various functions in accordance with exemplary embodiments of the present invention. For example, the memory device 46 could be configured to buffer input data for processing by the processor 40. Additionally or alternatively, the memory device 46 could be configured to store instructions for execution by the processor 40.

The processor 40 may be embodied in a number of different ways. For example, the processor 40 may be embodied as processing circuitry embodied as any of various processing means such as one or more instances of a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 40 may be configured to execute instructions stored in the memory device 46 or otherwise accessible to the processor 40. As such, whether configured by hardware or software methods, or by a combination thereof, the processor 40 may represent an entity (e.g., physically embodied in circuitry) capable of performing operations according to embodiments of the present invention while configured accordingly. Thus, for example, when the processor 40 is embodied as or includes an ASIC, FPGA or the like, the processor 40 may be specifically configured hardware for conducting the operations described herein. Alternatively, as another example, when the processor 40 is embodied as or includes an executor of software instructions, the instructions may specifically configure the processor 40 to perform the functions, algorithms and/or operations described herein when the instructions are executed. However, in some cases, the processor 40 may be a processor of a specific device (e.g., the CPU of a PC or other computing device) adapted for employing embodiments of the present invention by further configuration of the processor 40 by instructions for performing the functions, algorithms and/or operations described herein.

Meanwhile, the communication interface 44, which may be optional in some cases, may be any means such as a device or circuitry embodied in either hardware, software, or a combination of hardware and software that is configured to receive and/or transmit data from/to a network and/or any other device or module in communication with the apparatus. In this regard, the communication interface 44 may include, for example, an antenna (or multiple antennas) and supporting hardware and/or software for enabling communications with a wireless communication network. In fixed environments, the communication interface 44 may alternatively or also support wired communication. As such, the communication interface 44 may include a communication modem and/or other hardware/software for supporting communication via cable, digital subscriber line (DSL), Ethernet, universal serial bus (USB) or other mechanisms.

The user interface 42 may be in communication with the processor 40 to receive an indication of a user input at the user interface 42 and/or to provide an audible, visual, mechanical or other output to the user. As such, the user interface 42 may include, for example, a keyboard, a mouse, a joystick, a display, a touch screen, a microphone, a speaker, or other input/output mechanisms.

In an exemplary embodiment, the processor 40 may be embodied as, include or otherwise control a simulator engine 50. The simulator engine 50 may be any means such as a device or circuitry that may be operating in accordance with software or otherwise embodied in hardware or a combination of hardware and software (e.g., processor 40 operating under software control, the processor 40 embodied as an ASIC or FPGA specifically configured to perform the operations described herein, or a combination thereof) thereby configuring the device or circuitry to perform the corresponding functions of the simulator engine 50, as described below. In an exemplary embodiment, the simulator engine 50 may be hardware simulator software code defining a process control entity for the simulated hardware device. As such, for example, the simulator engine 50 may be software configured to emulate a controller or processor of the hardware being simulated. In some examples, the simulator engine 50 may further include code or instructions for management of sub-modules in accordance with exemplary embodiments of the present invention as described herein.

In this regard, a complete model of the hardware being simulated (e.g., modeled processing circuitry, memory, control registers, etc.) may include various sub-modules that describe particular model code portions or segments that are associated with a respective characteristic, activity, functionality or capability of the hardware being simulated. Thus, for example, a first sub-module 52, a second sub-module 54, and a third sub-module 56 may each be modeled to correspond to a respective different functionality. As such, for example, the first sub-module 52 and the third sub-module 56 may each include program code defining functionality associated with simulating hardware associated with respective different control registers. Meanwhile, the second sub-module 54 may include program code defining functionality associated with simulating hardware associated with an error correction module. Yet further modules or sub-modules may also exist as needed to fully model the hardware being simulated by the simulator engine 50 in connection with the sub-modules.

In an exemplary embodiment, the simulator engine 50 and the sub-modules (e.g., the first sub-module 52, the second sub-module 54 and the third sub-module 56) may together define a virtual platform 60 comprising a software implemented model of hardware that may be used to test or execute software (e.g., a software application 70, operating system, driver, middleware, etc.) via a host platform (which in this example is the apparatus 30 or more specifically the processor 40 and memory device 46). Thus, according to an exemplary embodiment, execution of the software application 70, which may be a software package in development or testing stages, may be accomplished via the virtual platform 60. By enabling execution of the software application 70 via the virtual platform 60, performance criteria such as processing speed, hardware-software interaction, resource sufficiency and other issues such as debugging may be analyzed prior to deployment of the actual hardware environment.

In an exemplary embodiment, the sub-modules may each be either activated or deactivated based on their desirability with respect to operation of the software application 70. As such, for example, each of the sub-modules (e.g., first sub-module 52, the second sub-module 54 and the third sub-module 56) may be selectably employed by the simulator engine 50 based on the employment of each respective sub-module during execution of the software application 70. A selected sub-module may be activated by the simulator engine 50 (e.g., under the ultimate control of the processor 40) to support a request for the functionality of the selected sub-module by the software application 70. Thus, for example, if access to a particular sub-module is sought by the software application 70, the simulator engine 50 may receive an indication of the attempt by the software application 70 to access the particular sub-module so that the simulator engine 50 can activate the particular sub-module to enable the software application 70 to access the particular sub-module.

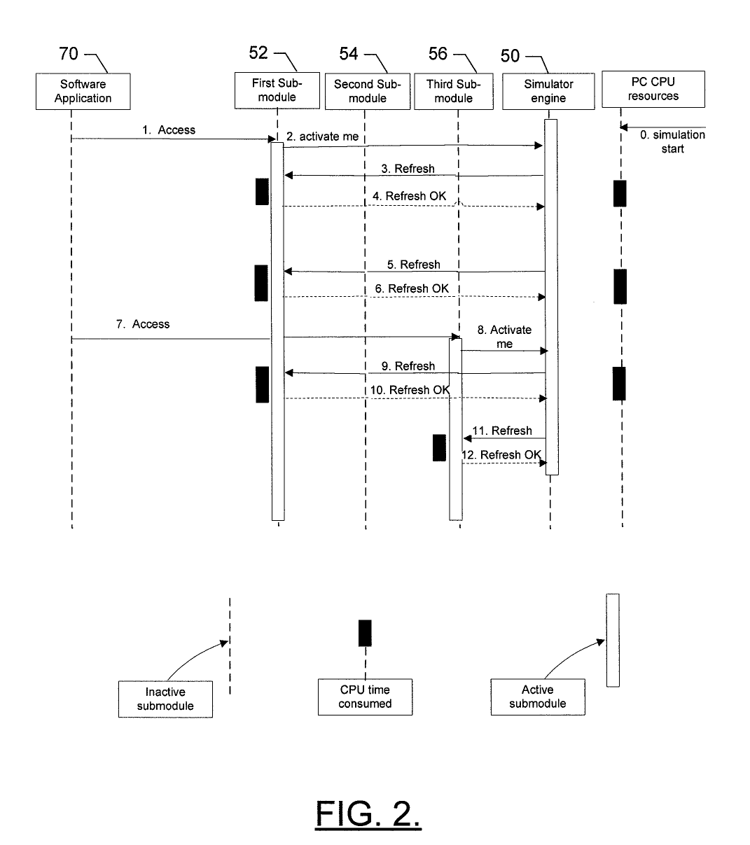

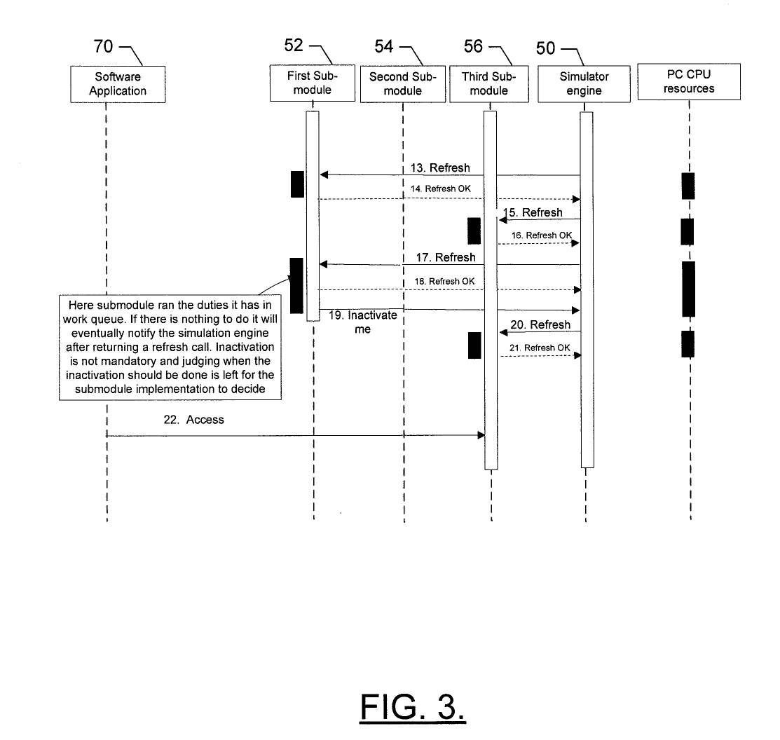

When a sub-module is activated, processing power or other resources of the host platform (e.g., the processor 40) may be employed to provide the modeled processing associated with the corresponding sub-module. However, when a sub-module is deactivated, no (or some negligible amount of) host platform processing power or resources may be employed. In an exemplary embodiment, a default or initial state of each sub-module may be a deactivated state. Thus, quite contrary to conventional techniques that have an initial active state and seek to deactivate sub-modules that will not be used by the software application, an exemplary embodiment of the present invention initially deactivates all sub-modules and only activates those that are accessed by the software application 70. Accordingly, by biasing the sub-modules toward a deactivated state, resource consumption of the host platform may be substantially reduced or minimized in order to provide for increased processing speed with respect to the simulated hardware associated with the virtual platform 60. Furthermore, in some embodiments, the simulator engine 50 may be further configured to deactivate sub-modules no longer in use. In this regard, for example, after access to a particular sub-module is complete (e.g., after a predetermined period of time of inactivity), the particular sub-module may be deactivated until another request for access to the particular sub-module is received (as shown below in FIG. 3). However in other embodiments, once a sub-module is activated, it may remain activated until specifically instructed to deactivate, or until the simulation or execution of the software application 70 is complete as shown below in FIG. 2. In some embodiments, a periodic refreshing of an activated sub-module may be undertaken by the simulator engine 50 after a predetermined time period has passed or in response to other stimuli, and the active sub-module may utilize host platform resources after each refreshing operation.

In an exemplary embodiment, the simulator engine 50 may be configured to receive an indication of a request, made by the software application 70, for access to a particular sub-module. The indication of the request may be received from the sub-module itself, or from the software application 70. In any case, after receiving the indication, the simulator engine 50 may be configured to activate the sub-module for which access was requested. The activation of a sub-module may be accomplished via a “refresh” message that may indicate that the corresponding sub-module is to be activated. After activation of the corresponding sub-module, resources of the host platform may be employed to execute functionality associated with the activated sub-module. After completion of the functionality for which access was requested, the sub-module may remain active, even though host platform resources may not be actively consumed. The simulator engine 50 may thereafter be configured to periodically refresh the sub-module, as appropriate, while the software application 70 continues to run. In this regard, for example, the periodic refreshment of a particular application may be made based on additional requests for access or based on other predefined criteria. FIG. 2 shows an example of the process described above.

In this regard, FIG. 2 illustrates a control flow diagram of one example of a process of dynamic activation of virtual platform sub-modules according to an exemplary embodiment of the present invention. As shown in FIG. 2, the initial state of each sub-module may be a deactivated (or inactive) state when a simulation (e.g., execution of the software application 70 by the virtual platform 60) is begun at operation 0. Due to inactivation of all of the sub-modules, no host platform (e.g., CPU) resources are initially consumed in relation to sub-module operation. At operation 1, the software application 70 may request access to the first sub-module 52 (e.g., for access to control registers). The first sub-module 52 may then provide an indication to the simulator engine 50 regarding the request for access made by the software application 70 at operation 2. The simulator engine may then activate the first sub-module 52 via a refresh message at operation 3. After activation of the first sub-module 52, host platform resources may be consumed in association with operation of the first sub-module 52 while hardware simulation sub-module code is being run. After running the hardware simulation sub-module code associated with the first sub-module 52, a “refresh ok” message may be utilized at operation 4 to indicate that the sub-module code of the first sub-module 52 has been run. Other refresh and refresh ok messages may be exchanged in association with subsequent running of the sub-module code of the first sub-module 52 as indicated between operations 5, 6, 9 and 10.

Other sub-modules 52 may also be activated when indications of requests for access thereto are received by the simulator engine 50. For example, as shown at operation 7, if a request for access to the third sub-module 56 is made by the software application 70, the simulator engine 50 may receive an indication of the request as shown at operation 8. In response to the indication, the simulator engine 50 may refresh the third sub-module 56 as shown at operation 11 and the host platform's resources may be consumed in association with running of the hardware simulation sub-module code of the third sub-module 56. After running of the hardware simulation sub-module code of the third sub-module 56, the third sub-module 56 may provide a refresh ok message to the simulator engine and active consumption of host platform resources may be suspended. Meanwhile, after activation of the third sub-module 56, both the first sub-module 52 and third sub-module 56 may be active while the second sub-module 54 remains inactive. However, in response to receipt of an indication that access was requested to the second sub-module 54, the simulator engine 50 would also activate the second sub-module 54.

As can be seen from FIG. 2, even if only three sub-modules are included and the second one is never utilized, whereas conventional systems would have the first and third sub-modules activated during the entire process, the dynamic activation provided by an exemplary embodiment of the present invention provides for saving host platform resources with respect to delaying activation of the third sub-module until such time as the third sub-module is actually requested for use. Thus, having the sub-modules in an initial deactivated state may reduce the loading on the host platform and therefore enable simulation of hardware to be accomplished in a manner that permits software being tested or otherwise operated on the simulated hardware to be run with less likelihood of experiencing excessive delay.

As discussed above, the embodiment of FIG. 2 shows a case where activated sub-modules remain activated after activation, even if the activated sub-modules are not to be used again during the process. FIG. 3 shows an alternative case in which a sub-module that was activated may be de-activated after use is no longer desired. In this regard, at operation 13, the first sub-module 52 may receive a refresh message from the simulator engine 50 and respond with a refresh ok message at operation 14. Similarly, the third sub-module 56 may receive a refresh message from the simulator engine 50 at operation 15 and respond with a refresh ok message at operation 16. After some period of time, the first sub-module 52 may receive a final refresh message from the simulator engine 50 at operation 17 and respond with a refresh ok message at operation 18. The first sub-module 52 may then be aware that it has completed its duties with respect to the current process and therefore request inactivation at operation 19. In response to the request for inactivation, the simulator engine 50 may inactivate the first sub-module 52. However, since the third sub-module 56 has not requested deactivation, the third sub-module 56 may continue to remain active and trade refresh/refresh ok messages with the simulator engine to enable the software module 70 to access the third sub-module 56 as shown at operations 20 to 22.

Although the example of FIG. 3 provides for the deactivation of a sub-module to be accomplished via a request for deactivation be the sub-module itself, other deactivation scenarios are also contemplated. For example, in some cases, the simulator engine 50 determines which sub-modules to deactivate and proactively deactivates such sub-modules accordingly. The deactivation may occur by failing to refresh a sub-module to be deactivated, by killing a process of the sub-module to be deactivated, by unloading the sub-module to be deactivated, and/or the like. The deactivation may be accomplished with or without permission from the sub-module to be deactivated in various alternative embodiments. As indicated above, a decision to deactivate a sub-module may be made (by the sub-module or by the simulator engine 50) based on, for example, a determination that all desired operation of the sub-module has been completed or based on a predetermined amount of inactive time (or simulation processor cycles) of the sub-module. In some instances, re-activation may be permitted the next time a request to access the sub-module is received. However, in some instances, the cycling of activation/deactivation operations may desirably be minimized. Thus, the simulator engine 50 and/or the sub-module may consider the likelihood or timing associated with activation/deactivation cycling to attempt to avoid excessive or otherwise counterproductive cycling.

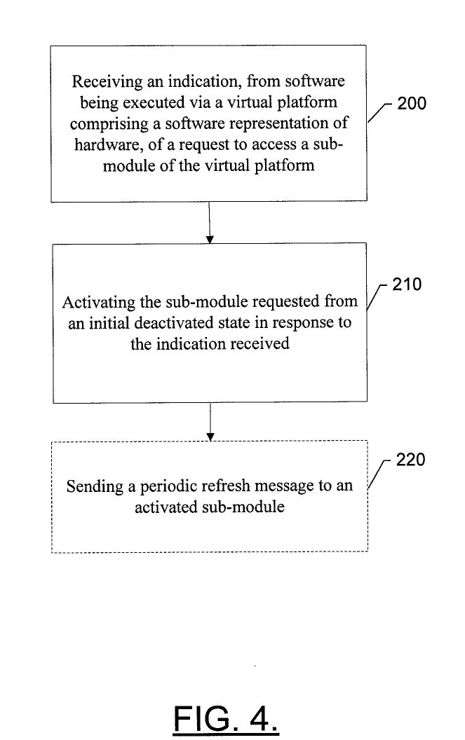

FIG. 4 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a computing device and executed by a processor in the computing device. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing dynamic activation of virtual platform sub-modules, as shown in FIG. 4, includes receiving an indication, from software being executed via a virtual platform comprising a software representation of hardware, of a request to access a sub-module of the virtual platform at operation 200. Of note, the indication may be the receipt of the request itself or some other normally generated trigger or stimulus that is generated to indicate the request. As such, for example, the indication is typically not a special message tailored to enable communication with the virtual platform. Instead, the indication is the same indication that the hardware that the virtual platform is modeling would receive when the request is made. Moreover, the “request” to access a software module is, in some examples, an attempt by the software to access or call the corresponding sub-module. The method further includes activating the sub-module requested from an initial deactivated state in response to the indication received at operation 210. Notably, as used herein, the terms “activated” or “activating” should be understood to correspond to loading, initializing, or otherwise making a particular sub-module available for operation. Thus, being “activated” does not necessarily require that a corresponding sub-module be currently “active”, but only that the corresponding sub-module has the ability to respond to stimuli or take action according to its programming when called upon to do so.

In some embodiments, certain ones of the operations above may be modified or further amplified as described below. It should be appreciated that each of the modifications or amplifications herein may be included with the operations and modifications above either alone or in combination with any others among the features described herein. In this regard, for example, receiving the indication may include receiving the indication relayed from the software via the sub-module requested or receiving the indication directly from the software. In an exemplary embodiment, activating the sub-module requested may include enabling the software to access the sub-module requested. In some cases, an activated sub-module may be enabled to generate events without external refreshment.

In some cases, further optional operations may be included in the method, an example of which is shown in dashed lines in FIG. 4. In this regard, for example, the method may further include sending a periodic refresh message to an activated sub-module at operation 220. In such an embodiment, the method may include defining a composite (e.g., average) paging period for the mobile terminal and the at least one other mobile terminal based on the paging period and the dynamic paging period.

In an exemplary embodiment, an apparatus for performing the method of FIG. 4 above may comprise a processor (e.g., the processor 40) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-220 may comprise, for example, the processor 40, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory storing computer program code configured to, with the at least one processor, cause the apparatus or another apparatus to at least perform the following:
receiving an indication, from software being executed via a virtual platform comprising a software representation of hardware, of a request to access a sub-module of the virtual platform; and
activating the sub-module requested from an initial deactivated state in response to the indication received.

2. The apparatus of claim 1, wherein the apparatus comprises a host platform configured to operate the virtual platform.

3. The apparatus of claim 1, wherein the apparatus comprises a processor of a host platform configured to operate the virtual platform.

4. The apparatus of claim 1, wherein the apparatus comprises a simulator engine comprising a plurality of instructions executed by a processor of a host platform configured to operate the virtual platform.

5. The apparatus of claim 1, wherein the virtual platform comprises a simulator engine and a plurality of sub-modules that each define a respective characteristic, activity, functionality or capability of the hardware being simulated.

6. The apparatus of claim 1, wherein each one of the plurality of sub-modules is initially deactivated and remains deactivated during execution of the software until activated in response to a corresponding request by the software for access to a respective one of the plurality of sub-modules, the corresponding request prompting activation of the respective one of the plurality of sub-modules.

7. The apparatus of claim 1, wherein a host platform operating the virtual platform includes processing resources that are not used in association with a deactivated sub-module, but are usable in connection with executing program code associated with an activated sub-module.

8. The apparatus of claim 1, wherein computer program code for causing the apparatus or the other apparatus to receive the indication includes instructions for causing the apparatus or the other apparatus to receive the indication relayed from the software via the sub-module requested.

9. The apparatus of claim 1, wherein computer program code for causing the apparatus or the other apparatus to receive the indication includes instructions for causing the apparatus or the other apparatus to receive the indication directly from the software.

10. The apparatus of claim 1, wherein computer program code for causing the apparatus or the other apparatus to activate the sub-module requested includes instructions for causing the apparatus or the other apparatus to enable the software to access the sub-module requested.

11. The apparatus of claim 1, further comprising computer program code for causing the apparatus or the other apparatus to send a periodic refresh message to an activated sub-module.

12. The apparatus of claim 1, further comprising computer program code for causing the apparatus or the other apparatus to enable access to the sub-module requested and enable the sub-module to respond to the access subsequent to being activated.

13. The apparatus of claim 1, further comprising computer program code for causing the apparatus or the other apparatus to enable the sub-module to generate events without external refreshment.

14. A method comprising:
receiving an indication, from software being executed via a virtual platform comprising a software representation of hardware, of a request to access a sub-module of the virtual platform; and
activating the sub-module requested from an initial deactivated state in response to the indication received.

15. The method of claim 14, wherein receiving the indication comprises receiving the indication relayed from the software via the sub-module requested.

16. The method of claim 14, wherein receiving the indication comprises receiving the indication directly from the software.

17. The method of claim 14, wherein activating the sub-module requested includes enabling the software to access the sub-module requested.

18. The method of claim 14, further comprising sending a periodic refresh message to an activated sub-module.

19. A computer program product comprising at least one computer-readable storage medium having computer-executable program code portions stored therein, the computer-executable program code portions comprising:
program code instructions for receiving an indication, from software being executed via a virtual platform comprising a software representation of hardware, of a request to access a sub-module of the virtual platform; and
program code instructions for activating the sub-module requested from an initial deactivated state in response to the indication received.

20. The computer program product of claim 19, wherein program code instructions for activating the sub-module requested include instructions for enabling the software to access the sub-module requested.
